(19) United States
(12) Patent Application Publication
(10) Pub. No.: US 2011/0304570 A1
(43) Pub. Date: Dec. 15, 2011

(54) TOUCH SCREEN DEVICE

(75) Inventors: Takami MAEDA, Fukuoka (JP); Masami HIRAKAWA, Fukuoka (JP)

(73) Assignee: Panasonic Corporation, Osaka (JP)

(21) Appl. No.: 13/156,446

(22) Filed: Jun. 9, 2011

(30) Foreign Application Priority Data
Jun. 11, 2010 (JP) 2010-134430

(51) Int. Cl. G06F 3/041

(52) U.S. Cl. 345/173

(57) ABSTRACT

A touch screen device is provided that includes a receiving signal processor, an odd number line FIFO, an even number line FIFO, and a first selector. The receiving signal processor processes output signals from receiving electrodes and outputs detection data. The odd number line FIFO and the even number line FIFO respectively store the detection data output from the receiving signal processor on a line basis. The first selector alternately selects outputs of the odd number line FIFO and the even number line FIFO. While one of the odd number line FIFO and the even number line FIFO performs writing of the detection data, the other performs reading.

### CROSS-REFERENCE TO RELATED APPLICATIONS

The present application claims priority under 35 U.S.C. §119 of Japanese Application No. 2010-134430, filed on Jun. 11, 2010, the disclosure of which is expressly incorporated by reference herein in its entirety.

### BACKGROUND OF THE INVENTION

1. Field of the Invention

The present invention relates to a capacitive touch screen device that has electrodes arranged in a grid pattern, and detects a touch position based on a variation in an output signal from the electrodes caused by the change in capacitance in response to a touch operation. In particular, the present invention relates to a mutual capacitance touch screen device that detects a touch position by receiving a charge-discharge current signal flowing through a receiving electrode in response to a drive signal applied to a transmission electrode.

2. Description of Related Art

The touch screen device is widely used in fields of personal computers or handheld terminals. On the other hand, the touch screen device can be used as an interactive white board, by combining the touch screen device with a large screen display device, to be used in a presentation or a lecture for a large audience.

There are various touch screen devices that employ different principles to detect a touch position. For example, in a capacitive touch screen device, in which a plurality of electrodes are arranged in a panel to detect change in capacitance in response to a touch operation by a pointing device, such as a finger, or the like, an amount of data necessary to obtain a touch position increases, as the number of electrodes increases. In particular, when the touch screen device is used as an interactive white board, the number of electrodes increases as the size of the touch screen device increases. Thus, the amount of data necessary to obtain a touch position increases by a large amount.

Such an increase in the amount of data may increase a processing time necessary to detect a touch position, and thus may cause a phenomenon that the processing for detecting a touch position cannot follow a touch operation by a pointing device, such as a finger, or the like. Accordingly, a configuration that enables high speed processing for detecting a touch position is desired. With regard to the desire of such high speed processing, a variety of technologies are conventionally known. (Related Art 1 to 4)

The above-described conventional technology can reduce the time necessary for a scanning operation, in which electrodes are selected one by one and an output signal from the selected electrode is processed, or can reduce the operation load of a controller that performs operation processing of a touch position. However, the above described conventional technology cannot reduce the time necessary for data transmission. In particular, in a mutual capacitance touch screen device that receives an output signal of a receiving electrode in response to a drive signal applied to a transmission electrode and outputs detection data for each electrode intersection, the number of electrode intersections increases drastically, as the size of the touch screen device increases. Therefore, an amount of data also becomes enormous, and the time necessary for data transmission increases. This causes a drastic reduction in speed of detection processing of a touch position.
Related Art 1: Japanese Patent Application Publication No. 2003-84904
Related Art 2: Japanese Patent Application Publication No. 2006-127101
Related Art 3: Japanese Patent Application Publication No. 2009-289235
Related Art 4: Japanese Patent Application Publication No. 2010-39852

### SUMMARY OF THE INVENTION

In view of the above-described circumstances, the present invention provides a touch screen device that can performs detection processing of a touch position at high speed, even if the number of electrodes increases, along with an increase in the size of the touch screen device.

An aspect of the present invention provides a touch screen device including: a panel body, on which a plurality of transmission electrodes extending parallel to each other and a plurality of receiving electrodes extending parallel to each other are arranged in a grid pattern, to provide a plurality of electrode intersections between the plurality of transmission electrodes and the plurality of receiving electrodes; a transmitter that applies a drive signal to each of the plurality of transmission electrodes; a receiver that receives an output signal from each of the plurality of receiving electrodes in response to the drive signal applied to each of the plurality of transmission electrodes, and outputs detection data of each of the plurality of electrode intersections; and a system controller that detects a touch position based on the detection data output from the receiver. The receiver comprises: a receiving signal processor that processes the output signal from each of the plurality of receiving electrodes, and outputs the detection data; two data storages that respectively store the detection data output from the receiving signal processor on a transmission electrode basis; and a first selector that alternately selects outputs of the two data storages such that one of the two data storages performs writing of the detection data while the other of the two storages performs reading of the detection data.

According to an aspect of the present invention, detection data can be transmitted to the system controller, using the time of performing a scanning operation. Accordingly, while a drive signal is applied to the transmission electrode, signals output from the receiving electrodes are processed. Accordingly, the scanning operation does not need to wait for the transmission of detection data, and thus, a processing speed of detecting a touch position can be improved.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a configuration diagram illustrating an overall touch screen system according to an embodiment of the present invention;

FIG. 2 is a schematic configuration diagram illustrating a touch screen device;

FIG. 3 is a schematic configuration diagram illustrating a receiving signal processor;

FIG. 4 is a diagram illustrating a state of a pulse signal application to a transmission electrode, and an operation state of a switching element provided for each receiving electrode;

FIG. 5 is a diagram illustrating a schematic configuration of a data transmitter of the receiving unit;

FIGS. 6A and 6B are diagrams illustrating transmission states of detection data in the receiving unit;

FIG. 7 is a timing chart illustrating an operation state of the receiving unit;

FIGS. 8A and 8B are diagrams, each illustrating a writing and a reading state of detection data in a data storage; and

FIG. 9 is a timing chart illustrating a storing and a transmitting state of detection data in the receiving unit.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

Embodiments of the present invention will be described hereinafter with reference to the drawings.

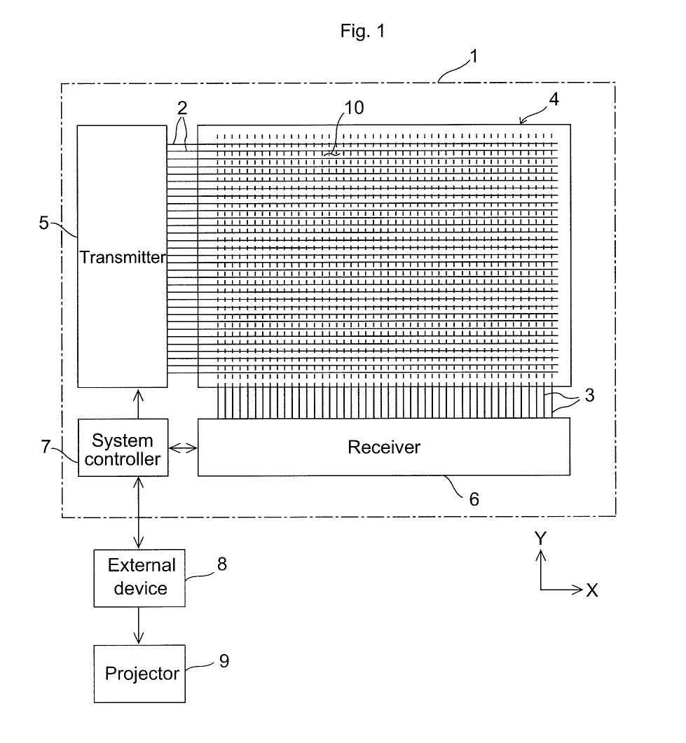

FIG. 1 is a configuration diagram illustrating an entire touch screen system according to an embodiment of the present invention. The touch screen device 1 includes a panel body 4, in which a plurality of transmission electrodes 2 extending parallel to each other and a plurality of receiving electrodes 3 extending parallel to each other are arranged in a grid pattern; a transmitter 5 that applies a drive signal (pulse signal) to the transmission electrodes 2; a receiver 6 that receives a charge-discharge current signal of the receiving electrodes 3 in response to the drive signal applied to the transmission electrodes 2, and outputs a level signal of each electrode intersection, at which a transmission electrode 2 intersects with a receiving electrode 3; and a system controller 7 that detects a touch position based on the level signal output from the receiver 6, and controls operations of the transmitter 5 and the receiver 6.

The touch screen device 1, combined with a large screen device, is used as an interactive white board, which can be used in a presentation or a lecture. In particular, in this embodiment, the touch screen device 1 is used in combination with a projector device, and a touch surface 10 of the touch screen device 1 is used as a screen for a projector.

Touch position information output from the touch screen device 1 is input to an external device 8, such as a personal computer, etc. An image corresponding to a user's touch operation performed on the touch surface 10 of the touch screen device 1, with a pointing device (a user's finger tip or a conductive body, such as a stylus or a pointing rod, etc.), is displayed on a display screen, which is projected and displayed on the touch surface 10 of the touch screen device 1 by a projector device 9, based on display screen data output from the external device 8. Thus, a desired image can be displayed with a feeling similar to that when the image is directly drawn on the touch surface 10 of the touch screen device 1 by a marker. Further, a button displayed on the display screen can be operated. Moreover, an eraser, which erases the image drawn by a touch operation, can also be used.

The transmission electrodes 2 and the receiving electrodes 3 are arranged at a same arrangement pitch (e.g., 10 mm), and the numbers thereof vary according to an aspect ratio of the panel body 4. For example, an arrangement including one hundred twenty (120) transmission electrodes 2 and one hundred eighty six (186) receiving electrodes 3 can be utilized.

The transmission electrodes 2 and the receiving electrodes 3 overlap each other with an insulating layer (support sheet) sandwiched therebetween, and intersect with each other. A capacitor is formed at an electrode intersection at which a transmission electrode 2 intersects with a receiving electrode 3. When a user performs a touch operation with a pointing device, capacitance at the electrode intersection is substantially reduced in response to the touch operation, and thereby it is possible to detect whether or not a touch operation is performed.

In this embodiment, a mutual capacitance touch screen device is used. Thus, when a drive signal is applied to the transmission electrode 2, a charge-discharge current flows in the receiving electrode 3 in response to the drive signal. At this moment, when capacitance at an electrode intersection changes in response to a user's touch operation, the charge-discharge current in the receiving electrode 3 also changes. The receiver 6 converts an amount of change in the charge-discharge current into a level signal (digital signal) of each electrode intersection, and outputs the level signal to the system controller 7. The system controller 7 calculates a touch position based on the level signal of each electrode intersection. In the mutual capacitance touch screen device, it is possible to perform multi-touch (or multipoint detection), which detects a plurality of touch positions simultaneously.

The system controller 7 obtains a touch position (a central coordinate of a touch area) from the level signal of each electrode intersection output from the receiver 6, using a predetermined calculation process. In the calculation of the touch position, the touch position is obtained from level signals of a plurality of electrode intersections (e.g. 4×4), which are adjacent to each other in the x-axis direction (the direction in which the transmission electrode 2 extends) and in the y-axis direction (the direction in which the receiving electrode 3 extends), by using a desired interpolating method (e.g., centroid method). Thus, it is possible to detect a touch position with a resolution (e.g., equal to or less than 1 mm) higher than the arrangement pitch (10 mm) of transmission electrodes 2 and the receiving electrodes 3.

Further, the system controller 7 performs a process to obtain a touch position every frame period, in which reception of the level signal of each electrode intersection is completed over the entire touch surface 10, and outputs touch position information to the external device 8 in frame units. The external device 8 generates display screen data that connects the touch positions in time series based on the touch position information of a plurality of temporally successive frames, and outputs the display screen data to the projector device 9. In a multi-touch operation, touch position information including multiple touch positions by pointing devices is output in frame units.

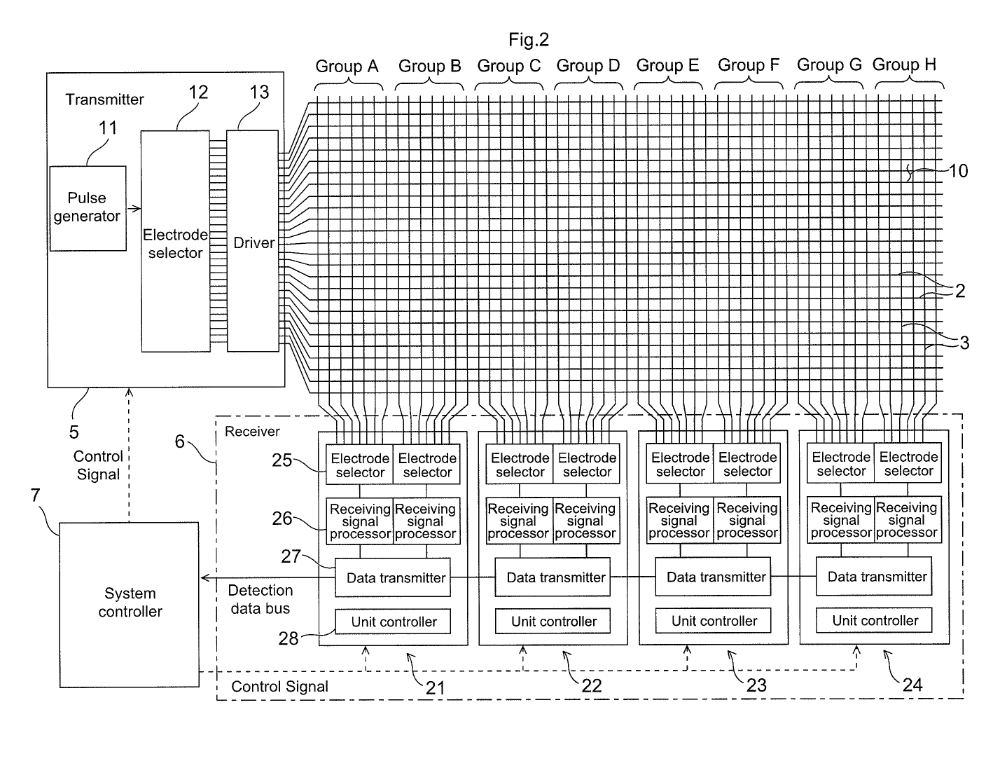

FIG. 2 is a schematic configuration diagram of the touch screen device 1. The transmitter 5 selects the transmission electrodes 2 one by one, and sequentially applies a pulse signal (drive signal) to the selected transmission electrode 2. The transmitter 5 includes a pulse generator 11, an electrode selector 12 and a driver 13. The pulse generator 11 generates a pulse at a predetermined time. The electrode selector 12 applies the pulse generated by the pulse generator 11 to a selected transmission electrode 2 based on a horizontal synchronization signal. The driver 13 pulse-drives the selected transmission electrode 2.

The receiving electrodes 3 are grouped together every predetermined number of electrodes. In this embodiment, one hundred eighty six (186) receiving electrodes 3 are divided into eight (8) groups A-H, a group for every twenty four (24) electrodes. Each of seven groups A-G includes twenty four (24) electrodes, and the last group H includes eighteen (18) electrodes.

The receiver 6 includes first-fourth receiving units 21-24. In this embodiment, one of the receiving units 21-24 is provided for every two groups of receiving electrodes. Thus, four receiving units are provided in total. The receiving units 21-24 concurrently process the output signals from the receiving electrodes 3. The receiving units 21-24 have a common configuration so as to be interchangeable with each other.

Each of the receiving units 21-24 includes an electrode selector 25, a receiving signal processor 26, a data transmitter 27 and a unit controller 28. In the electrode selector 25, a switching element is connected to each receiving electrode 3. While a pulse signal is applied to one of the transmission electrodes 2, the electrode selector 25 selects the receiving electrodes 3 one by one, and sequentially inputs the charge-discharge current signals from the receiving electrodes 3 to the receiving signal processor 26. Switching elements of the electrode selector 25 are individually controlled to be turned ON and OFF by the unit controller 28.

The electrode selector 25 and the receiving signal processor 26 are provided for each group of the receiving electrodes 3. On-off control of mutually corresponding switching elements included in respective electrode selectors 25 is concurrently performed. In each group, the switching elements are controlled to be turned ON one by one. The rest of the switching elements are controlled to remain OFF. The charge-discharge current signal of a single receiving electrode 3, selected by turning ON the corresponding switching element, is input to the receiving signal processor 26.

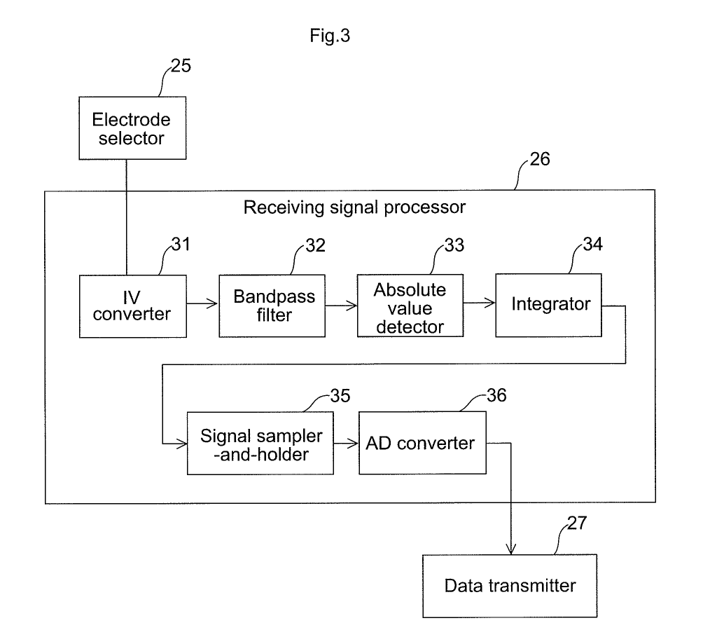

FIG. 3 is a schematic configuration diagram illustrating the receiving signal processor 26. The receiving signal processor 26 includes an IV converter 31, a bandpass filter 32, an absolute value detector 33, an integrator 34, a signal sampler-and-holder 35 and an AD converter 36.

The IV converter 31 converts the charge-discharge current signal (analog signal) of the receiving electrode 3, input through the electrode selector 25, into a voltage signal. The bandpass filter 32 performs an operation to remove a signal having a frequency component other than the frequency of the drive signal applied to the transmission electrode 2, from the output signals from the IV converter 31. The absolute value detector (rectifier) 33 applies a full-wave rectification to the output signals from the bandpass filter 32. The integrator 34 performs an operation to integrate the output signal from the absolute value detector 33 along the time axis. The signal sampler-and-holder 35 performs an operation to sample the output signal from the integrator 34 at a predetermined time. The AD converter 36 performs an AD conversion of the output signal from the signal sampler-and-holder 35, and outputs a level signal (digital signal) to the data transmitter 27.

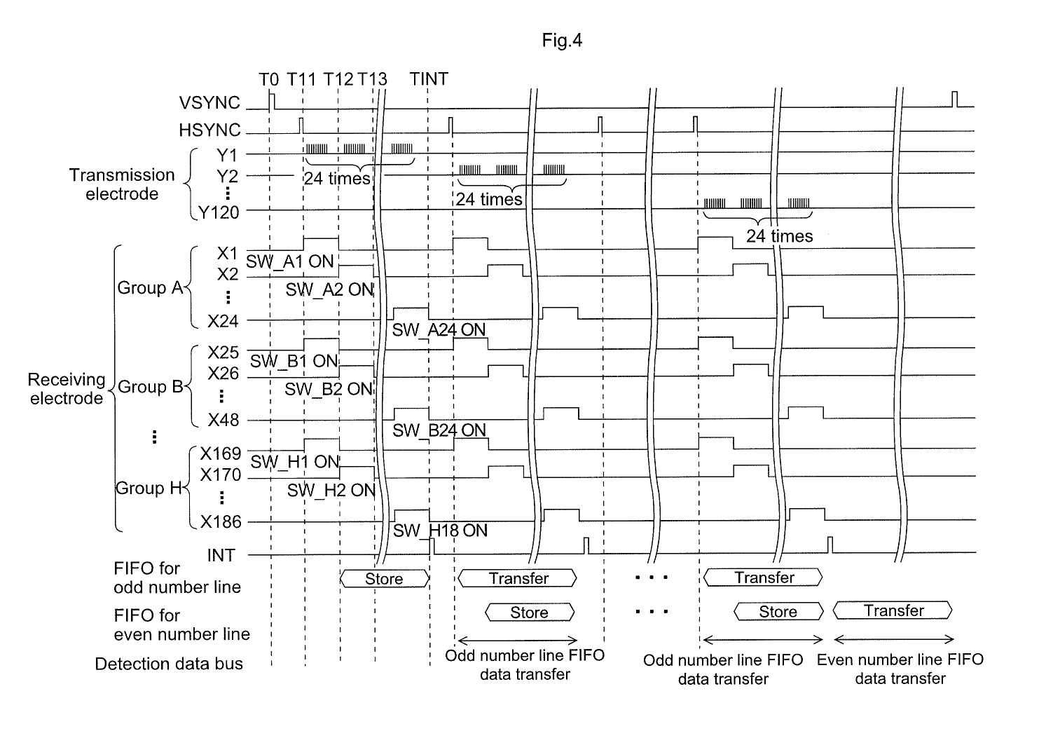

FIG. 4 is a diagram illustrating a state of a pulse signal application to the transmission electrode 2, and an operation state of the switching elements respectively provided for the receiving electrodes 3. In this embodiment, the one hundred twenty (120) transmission electrodes 2 are denoted as Y1, Y2, . . . , Y120, starting from an end. The one hundred eighty six (186) receiving electrodes 3 are denoted as X1, X2, . . . , X186, starting from an end, and are divided into eight groups A-H, a group for every 24 electrodes.

Firstly, a vertical synchronization signal (VSYNC), defining a start time of one frame, is output from the system controller 7 to the transmitter 5 (time t0). Then, a horizontal synchronization signal (HSYNC), defining a time for applying a drive signal to each transmission electrode 2, is output from the system controller 7 to the transmitter 5 (time T11, T12, T13, . . . ). A drive signal is applied to the transmission electrode 2 in accordance with the horizontal synchronization signal (HSYNC). For one transmission electrode 2, a set of pulses, including a predetermined number (e.g. 10) of pulses corresponding to one receiving electrode 3, is applied repeatedly twenty four (24) times, which corresponds to the number of receiving electrodes 3 included in one group, except group H.

The horizontal synchronization signal (HSYNC) is also output to the receiver 6. In this embodiment, this horizontal synchronization signal defines the time of on-off control of the switching elements (SW_A1-SW_A24, SW_B1-SW_B24, SW_H1-SW_H18). In the receiver 6, the switching elements corresponding to respective receiving electrodes 3 are sequentially turned ON in accordance with the horizontal synchronization signal (HSYNC). By doing so, during a period in which one receiving electrode 3 is selected, i.e., a period (e.g., T11, . . . , T12) in which a switching element corresponding to the one receiving electrode 3 is turned ON, a predetermined number of pulses are applied to the transmission electrode 2, and signals output from the receiving electrode 3 in response to the pulses are processed.

Thus, output signals of the twenty four (24) receiving electrodes 3 included in one group are sequentially output from the electrode selector 25 to the receiving signal processor 26. Mutually corresponding output signals in respective groups are concurrently processed.

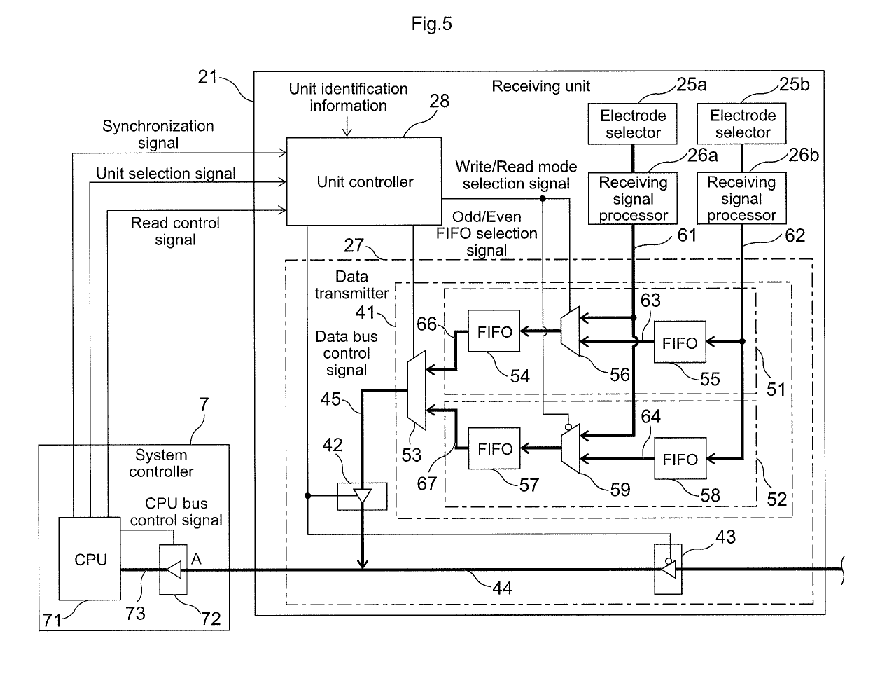

FIG. 5 is a diagram illustrating a schematic configuration of a data transmitter 27 in each of the receiving units 21-24. In FIG. 5, a first receiving unit 21 is shown. However, the other second to fourth receiving units 22-24 have the same configuration.

The data transmitter 27 includes a data storage 41, a first tri-state buffer (first switch) 42, a second tri-state buffer (second switch) 43, a detection data bus (first data transmission path) 44 and a FIFO read bus (second data transmission path) 45.

The detection data bus 44 is provided such that the receiving units 21-24 are connectable to each other in series, and sequentially transmits detection data, which is generated in each of the receiving units 21-24. Detection data output from the upstream receiving units 22-24 are transmitted to the system controller 7 through the downstream receiving units 21-23. The FIFO read bus 45 guides the detection data output from the data storage 41 to the detection data bus 44.

The first tri-state buffer 42 is provided on the FIFO read bus 45, and turns ON and OFF the delivery of detection data to the detection data bus 44. The detection data generated by the receiving units 21-24 can be delivered to the detection data bus 44 and be transmitted to the system controller 7 by controlling the first tri-state buffer 42 to be in a connected state. On the other hand, when the detection data is transmitted from the upstream receiving units 22-24, data is prevented from being delivered from the downstream receiving units 21-23 to the detection data bus 44 by controlling the first tri-state buffer 42 to be in a disconnected state.

The second tri-state buffer 43 is provided on the detection data bus 44 and upstream of a junction of the detection data bus 44 and the FIFO read bus 45. The second tri-state buffer 43 turns ON and OFF the transmission of detection data transferred from the upstream receiving units 22-24 to downstream side. By controlling the second tri-state buffer 43 to be in a connected state, transmission of detection data from the upstream receiving units 22-24 is allowed. On the other hand, by controlling the second tri-state buffer 43 to be in a disconnected state, transmission of data from the upstream receiving units 22-24 can be prevented.

The first tri-state buffer 42 and the second tri-state buffer 43 are controlled by the unit controller 28, and perform a switching operation between an ON state (connected state) and an OFF state (high impedance state: disconnected state), based on a data bus control signal output from the unit controller 28. The first tri-state buffer 42 and the second tri-state buffer 43 operate in conjunction with each other. When one is in a connected state, the other is in a disconnected state.

The system controller 7 inputs a unit selection signal (control signal), requesting delivery of detection data, to the unit controller 28. The unit controller 28 outputs a data bus control signal based on the unit selection signal. The unit controller 28 compares unit identification information stored in the receiving unit 21 with the unit selection signal output from the system controller 7. When the unit controller 28 detects that its own receiving unit is selected based on the comparison, the unit controller 28 outputs a data bus control signal such that the detection data stored in the data storage 41 is delivered to the detection data bus 44.

In other words, when the unit controller 28 detects that its own receiving unit is selected based on the unit selection signal received from the system controller 7, the unit controller 28 outputs a data bus control signal that turns ON the first tri-state buffer 42 and turns OFF the second tri-state buffer 43. On the other hand, when the unit controller 28 detects that its own receiving unit is not selected based on the unit selection signal received from the system controller 7, the unit controller 28 outputs a data bus control signal that turns OFF the first tri-state buffer 42 and turns ON the second tri-state buffer 43.

In this embodiment, the unit identification information of the first to fourth receiving units 21-24 are respectively set to 00, 01, 10 and 11. The unit identification information is set and held by using, for example, a dip switch, and is input to the unit controller 28, as a unit identification signal.

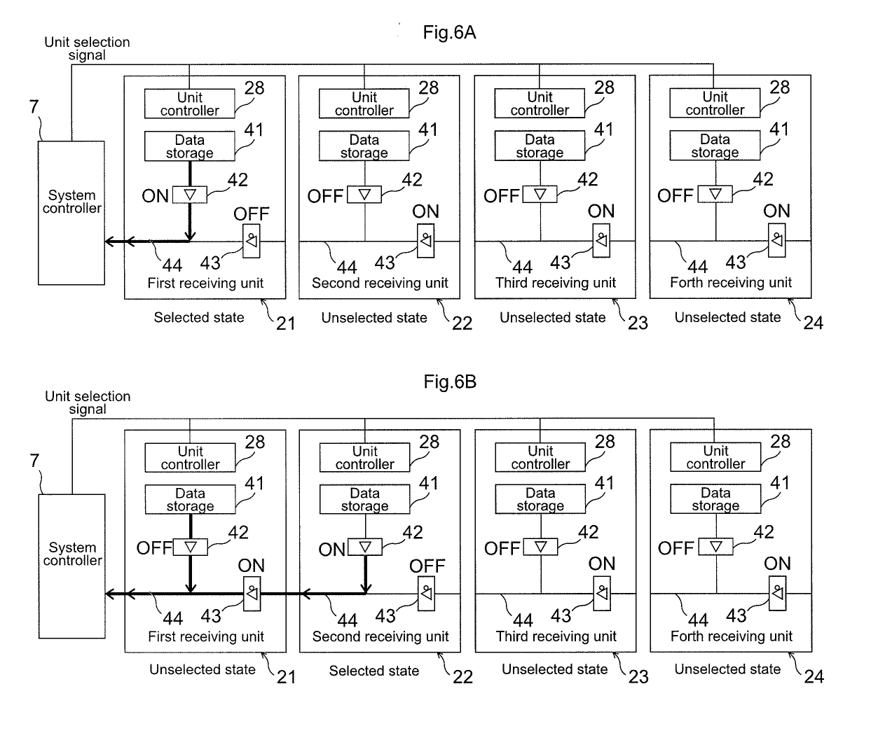

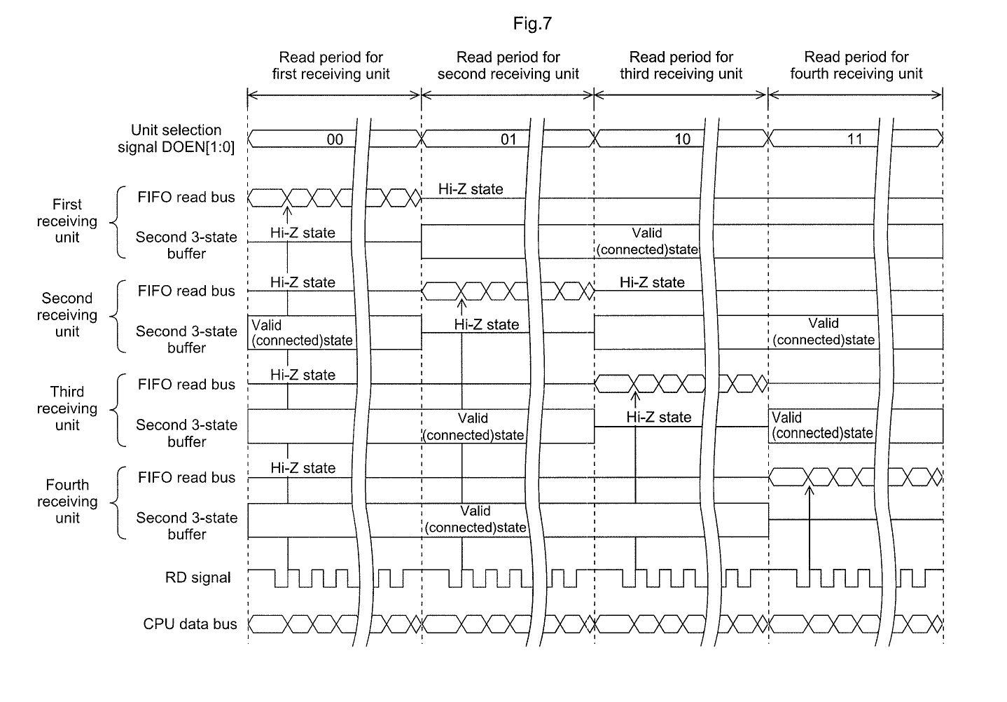

FIGS. 6A and 6B are diagrams, each illustrating a transmission state of detection data in the receiving units 21-24. FIG. 7 is a time chart illustrating an operation state of the receiving units 21-24.

As shown in FIG. 7, the system controller 7 outputs a unit selection signal (DOEN signal) to the first to fourth receiving units 21-24. In each of the first to fourth receiving units 21-24, the unit controller 28 determines whether or not its own receiving unit is selected by comparing the unit selection signal with the unit identification information (00, 01, 10, 11). The unit selection signal (DOEN signal) changes at predetermined times in sequence, and thus, the first to fourth receiving units 21-24 sequentially enter a selected state.

FIG. 6A illustrates a state when the first receiving unit 21 is selected. In this case, the first tri-state buffer 42 of the first receiving unit 21 is tuned ON (connected state), and the detection data in the data storage 41 of the first receiving unit 21 is transmitted to the system controller 7 through the detection data bus 44. On the other hand, the second tri-state buffer 43 of the first receiving unit 21 is turned OFF (Hi-Z state: disconnected state), and data can be prevented from being transferred from the upstream second to fourth receiving units 22-24 to the system controller 7.

FIG. 6B illustrates a state when the second receiving unit 22 is selected. In this case, the first tri-state buffer 42 of the second receiving unit 22 is turned ON (connected state), and detection data in the data storage 41 of the second receiving unit 22 is transferred to the system controller 7 through the detection data bus 44. On the other hand, the second tri-state buffer 43 of the second receiving unit 22 is turned OFF (Hi-Z state: disconnected state), and data can be prevented from being transferred from the upstream third and fourth receiving units 23, 24 to the system controller 7.

Further, in this case, the downstream first receiving unit 21 is in an unselected state, and thus, the second tri-state buffer 43 is ON (connected state) so as not to prevent the transmission of detection data from the second receiving unit 22, and the first tri-state buffer 42 is OFF (Hi-Z state: disconnected state) so as to prevent the delivery of data from the first receiving unit 21 to the detection data bus 44.

As described above, in the receiving units 21-24, data transmission, in which the detection data in the data storage 41 is delivered to the detection data bus 44 and is further transmitted to the system controller 7, is controlled by ON and OFF operation of the first tri-state buffer 42 and the second tri-state buffer 43. The unit controller 28 controls the ON and OFF operation of the first tri-state buffer 42 and the second tri-state buffer 43 based on the unit selection signal output from the system controller 7. Thus, the system controller 7 can control data transmission of the entire system, by only outputting the unit selection signal to the receiving units 21-24.

In addition, the system controller 7 outputs a read control signal (RD signal) to the unit controller 28 (see FIG. 7). The read control signal synchronizes the receiving unit 21 and the system controller 7 in tenas of input and output timing of detection data. Based on the read control signal, the unit controller 28 delivers detection data to the detection data bus 44 and the system controller 7 obtains the detection data from the detection data bus 44.

The unit controller 28 of the receiving unit 21 detects receiving signals of the twenty four (24) receiving electrodes 3 that belongs to one group, and then outputs an interruption signal (INT) to the system controller 7 (see FIG. 4). The CPU 71 of the system controller 7 enters a read state upon detecting the interruption signal (INT), to sequentially obtain the detection data output from the receiving unit 21, and to write the detection data in a memory (RAM).

Here, the unit selection signal (DOEN signal) serves as an access signal that specifies one of the receiving units 21-24 to be in a selected state. In this embodiment, the unit selection signal is generated based upon a horizontal synchronization signal, without using a normal address signal (Axx) of the CPU 71. By doing so, the receiving unit 21 can enter a selected state more quickly than in the case of using the address signal of the CPU 71, and thus, the detection data of the receiving units 21-24 can be delivered to the detection data bus 44 in an earlier stage.

In this embodiment, the unit selection signal (DOEN signal) switches while the read control signal is continuously output, thereby turning ON (connected state) the first tri-state buffer 42 in the selected receiving unit 21-24 to deliver detection data to the detection data bus 44.

The unit selection signal (DOEN signal) is maintained in a constant state (active) during a read period in which one of the receiving units 21-24 sequentially outputs detection data. During this period, the first tri-stated buffer 42 is constantly ON (connected state), and at each leading edge of the read control signal (RD signal), the detection data to be read next arrives, in advance, at a point close to the tri-state buffer 72 of the system controller 7 (see FIG. 7). Therefore, data transmission can be accelerated, compared with a configuration in which the receiving units 21-24 starts data transmission in response to a data transmission command from the system controller 7.

Next, the data storages 41 in the receiving units 21-24 will be described. As shown in FIG. 5, the data storage 41 includes an odd number line FIFO (per-line data storage) 51, an even number line FIFO (per-line data storage) 52, and a first selector 53.

The odd number line FIFO 51 and the even number line FIFO 52 respectively store lines of detection data output from the receiving signal processors 26a, 26b. The odd number line FIFO 51 temporarily stores one line of detection data output from the receiving signal processors 26a, 26b while a drive signal is applied to an odd number line of the transmission electrodes 2. The even number line FIFO 52 temporarily stores one line of detection data output from the receiving signal processors 26a, 26b while a drive signal is applied to an even number line of the transmission electrodes 2.

The first selector 53 alternately selects output buses 66 and 67 of the odd number line FIFO 51 and the even number line FIFO 52, such that while one of the odd number line FIFO 51 and the even number line FIFO 52 writes detection data, the other reads detection data.

The first selector 53 is controlled by the unit controller 28, and performs a switching operation based on an odd/even FIFO selection signal output from the unit controller 28. The system controller 7 inputs a horizontal synchronization signal to the unit controller 28. The horizontal synchronization signal defines a time to apply a drive signal to each transmission electrode 2. The odd/even FIFO selection signal is output based on the horizontal synchronization signal. Thus, the system controller 7 can control the first selector 53 with the horizontal synchronization signal.

The odd number line FIFO 51 includes a first FIFO memory 54, a second FIFO memory 55 and a second selector 56. Similarly to the odd number line FIFO 51, the even number line FIFO 52 also includes a first FIFO memory 57, a second FIFO memory 58, and a second selector 59.

The first FIFO memories 54, 57 temporarily store detection data output from the first receiving signal processor 26a. The second FIFO memories 55, 58 temporarily store detection data output from the second receiving signal processor 26b. The second selectors 56, 59 are respectively serially connected between the first FIFO memories 54, 57 and the second FIFO memories 55, 58, and select an output bus 61 of the receiving signal processor 26a at the time of writing, and select output buses 63, 64 of the second FIFO memories 55, 58 at the time of reading.

Detection data of each receiving electrode 3 has one byte data length. Each of the first FIFO memories 54, 57 and the second FIFO memories 55, 58 has twenty four (24) byte memory capacity, such that detection data of twenty four (24) receiving electrodes 3 belonging to one group can be stored at a time.

The second selectors 56, 59 are controlled by the unit controller 28, and perform a switching operation based on a write/read mode selection signal output from the unit controller 28. The unit controller 28 outputs the write/read mode selection signal based on the horizontal synchronization signal input from the system controller 7. Thus, the system controller 7 can control the second selectors 56, 59 with the horizontal synchronization signal.

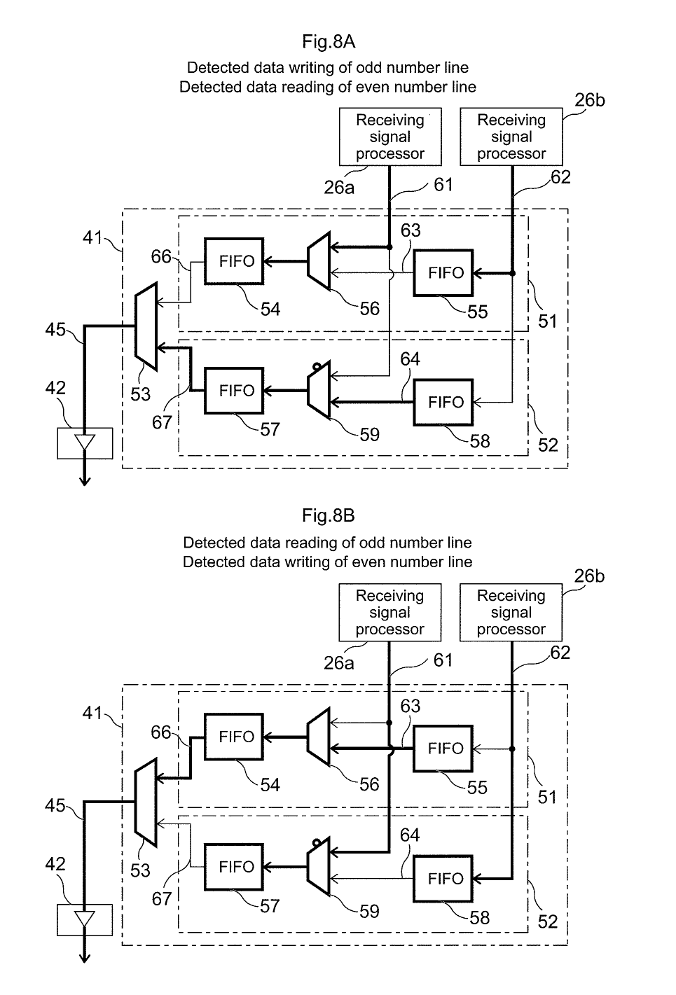

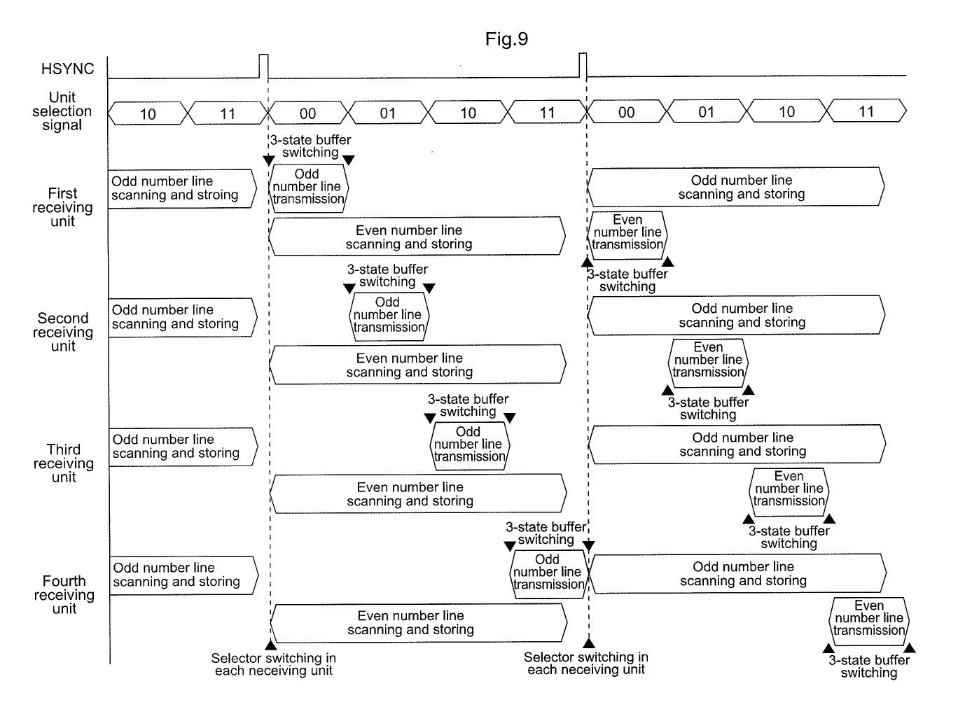

FIGS. 8A and 8B are diagrams, each illustrating a writing and reading state of detection data in the data storage 41 of the receiving unit 21. FIG. 9 is a time chart illustrating a storing and transmitting state of detection data in the receiving unit 21.

In the data storage 41, the first selector 53 and the second selectors 56, 59 perform a switching operation in conjunction with each other, such that the first state shown in FIG. 8A and the second state shown in FIG. 8B are alternately repeated.

In the first state shown in FIG. 8A, writing of detection data is performed at the odd number line FIFO 51, reading of detection data is performed at the even number line FIFO 52, and the first selector 53 selects the output bus 67 of the even number line FIFO 52.

In the first state, in the odd number line FIFO 51 in a writing state, the second selector 56 selects the output bus 61 of the first receiving signal processor 26a, such that the detection data from the first receiving signal processor 26a is written into the first FIFO 54. On the other hand, the detection data of the second receiving signal processor 26b is written into the second FIFO 55 through the output bus 62. Further, in the even number line FIFO 52 in a reading state, the second selector 59 selects the output bus 64 of the second FIFO 58, such that the detection data stored in the second FIFO 58 is transferred to the first selector 53 via the first FIFO 57.

In the second state shown in FIG. 8B, reading of detection data is performed at the odd number line FIFO 51, writing of detection data is performed at the even number line FIFO 52, and the first selector 53 selects the output bus 66 of the odd number line FIFO 51.

In the second state, in the odd number line FIFO 51 in a reading state, the second selector 56 selects the output bus 63 of the second FIFO 55, such that the detection data stored in the second FIFO 55 is transferred to the first selector 53 via the first FIFO 54. Further, in the even number line FIFO 52 in a writing state, the second selector 59 selects the output bus 61 of the first receiving signal processor 26a, such that the detection data from the first receiving signal processor 26a is written into the first FIFO 57. On the other hand, the detection data of the second receiving signal processor 26b is written into the second FIFO 58 through the output bus 62.

As described above, the data storages 41 in the receiving units 21-24, writing and reading operations of each line of detection data is controlled by the switching operations of the first selector 53 and the second selectors 56, 59. The switching operations of the first selector 53 and the second selectors 56, 59 are controlled by the unit controllers 28 based on the horizontal synchronization signals output from the system controller 7. Thus, the system controller 7 can control the data transmission in the receiving units 21-24, by merely outputting the horizontal synchronization signals to the receiving units 21-24.

Furthermore, at the time of reading, in the odd number line FIFO 51, the first FIFO memory 54 and the second FIFO memory 55 integrally operate as a single FIFO having a double capacity; and similarly, in the even number line FIFO 52, the first FIFO memory 57 and the second FIFO memory 58 integrally operate as a single FIFO having a double capacity. Accordingly, the second selectors 56, 59 can be operated only at the time of switching between writing and reading, and thus, the control is simplified.

As described above, in the data storages 41 of the receiving units 21-24, while one of the odd number line FIFO 51 and the even number line FIFO 52 writes detection data, the other reads detection data. The writing and reading of detection data is performed on a line basis, and the detection data read at this time is transmitted to the system controller 7, without being changed.

In other words, as shown in FIG. 9, scanning operations, in which a drive signal is applied to the transmission electrode 2 and signals output from the receiving electrodes 3 are processed, are repeated alternately between the odd number line and the even number line. At this time, the detection data obtained by a one-line scanning operation is temporarily stored in either the odd number line FIFO 51 or the even number line FIFO 52, depending upon whether the transmission electrode 2 to which the drive signal is applied is an odd line or an even line. In a scanning operation of the next line, previously stored detection data is transmitted to the system controller 7. Such storing and transmitting are repeated alternately on a line by line basis.

Further, the receiving units 21-24 perform the per-line transmission of detection data by time-sharing. The receiving units 21-24 enter a selected state in turn, based on the unit selection signal (DOEN signal) input from the system controller 7. In response thereto, the first tri-state buffer 42 and the second tri-state buffer 43 are switched, such that the receiving units 21-24 sequentially transmit the detection data on a line basis, to the system controller 7.

As described above, since detection data is transmitted to the system controller 7 by using a time period in which a scanning operation for each line is performed, the scanning operation does not need to wait for the transmission of detection data, and thus the processing speed to detect a touch position can be improved.

Further, the system controller 7 can control the data transmission operation of the receiving unit 21 only by using basic control signals, i.e., a synchronization signal, a unit selection signal and a read control signal. Thus, it is not necessary to provide a controller dedicated to data transmission, such as a DMA controller, in the receiving unit 21. Accordingly, manufacturing cost can be reduced.

In the above described example, each of the receiving units 21-24 includes two receiving signal processors 26 and two pairs of FIFO memories 54, 55, 57 and 58, and each of the receiving units 21-24 performs a process for two groups of receiving electrodes 3. However, three or more receiving signal processors and three of more pairs of FIFO memories may be provided in each of the receiving units 21-24, and each receiving unit may perform a process for three or more groups of the receiving electrodes 3.

The touch screen device according to the features of the present invention has an advantageous effect that, even if the number of electrodes increases along with the increase in size of the device, the detection process of a touch position can be performed at a high speed. Thus, the touch screen device according to the features of the present invention is useful as a capacitive touch screen device, in particular, as a mutual capacitance touch screen device.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A touch screen device, comprising:
a panel body, on which a plurality of transmission electrodes extending parallel to each other and a plurality of receiving electrodes extending parallel to each other are arranged in a grid pattern, to provide a plurality of electrode intersections between the plurality of transmission electrodes and the plurality of receiving electrodes;
a transmitter that applies a drive signal to each of the plurality of transmission electrodes;
a receiver that receives an output signal from each of the plurality of receiving electrodes in response to the drive signal applied to each of the plurality of transmission electrodes, and outputs detection data of each of the plurality of electrode intersections; and
a system controller that detects a touch position based on the detection data output from the receiver,
the receiver comprising:
a receiving signal processor that processes the output signal from each of the plurality of receiving electrodes, and outputs the detection data;
two data storages that respectively store the detection data output from the receiving signal processor on a transmission electrode basis; and
a first selector that alternately selects outputs of the two data storages such that one of the two data storages performs writing of the detection data while the other of the two storages performs reading of the detection data.

2. The touch screen device according to claim 1, comprising a plurality of receiving signal processors.

3. The touch screen device according to claim 2, wherein the plurality of receiving electrodes are divided into a plurality of groups, each group including a predetermined number of receiving electrodes, and the receiver comprises a plurality of receiving units that respectively and concurrently process output signals from the plurality of groups.

4. The touch screen device according to claim 3, wherein each of the receiving units has two receiving signal processors.

5. The touch screen device according to claim 4, wherein each of the two data storage comprises:
a first memory that temporarily stores detection data output from the first receiving signal processor;
a second memory that temporarily stores detection data output from the second receiving signal processor; and
a second selector that is serially connected between the first memory and the second memory, wherein the second selector selects an output of the first receiving signal processor during writing, and selects an output of the second memory during reading.

6. The touch screen device according to claim 5, wherein the first memory is a FIFO memory.

7. The touch screen device according to claim 5, wherein the second memory is a FIFO memory.

8. The touch screen device according to claim 1, wherein the two data storages store the detection data for the even number transmission electrodes and odd number transmission electrodes, respectively.

9. The touch screen device according to claim 3, wherein each of the plurality of receiving units comprises a first data transmission path provided such that the plurality of receiving units are connectable in series to each other.

10. The touch screen device according to claim 9, wherein each of the plurality of receiving units further comprises:
a second data transmission path that guides the detection data output from the receiving signal processor to the first data transmission path; and
a first switch that is provided on the second data transmission path, and turns ON and OFF to control the delivery of the detection data to the first data transmission path.

11. The touch screen device according to claim 10, wherein each of the plurality of receiving units further comprises a second switch that is provided on the first data transmission path and upstream of a junction of the first data transmission path and the second data transmission path,
wherein the second switch turns ON and OFF to control transmission of the detection data output from an upstream receiving unit of the plurality of receiving units to a downstream side of the junction.

12. The touch screen device according to claim 11, wherein one of the first switch and the second switch is ON when the other of the first switch and the second switch is OFF.

13. The touch screen device according to claim 3, wherein the plurality of receiving units perform reading of detection data by time-sharing.

14. The touch screen device according to claim 13, wherein each of the plurality of receiving units receives unit identification information of the receiving unit, compares the unit identification information with a unit selection signal output from the system controller, and delivers detection data of the receiving unit when the unit identification information matches the unit selection signal.

15. The touch screen device according to claim 11, wherein each of the first switch and the second switch comprises a tri-star buffer.

16. The touch screen device according to claim 3, wherein each of the plurality of receiving units stores unit identification information and comprises a unit controller that receives a unit selection signal from the system controller, the unit controller compares the unit identification information with the unit selection signal and when the unit identification information of one of the plurality of receiving units agrees with a unit selection signal, the unit controller outputs a signal enabling delivery of the detection data from the one of the plurality of receiving units to the system controller and prevents delivery of detection data from any other of the plurality of receiving units.

17. The touch screen device according to claim 16, wherein the system controller generating a synchronization signal, the unit selection signal being generated based upon the synchronization signal.

18. The touch screen device according to claim 1, wherein the two data storages comprise an odd number line FIFO and an even number line FIFO, and the first selector is configured to alternately select outputs of the two data storages based upon a synchronization signal output from the system controller.

19. The touch screen device according to claim 1, wherein each of the two data storages comprises a first FIFO memory, a second FIFO memory and an additional selector.

20. The touch screen device according to claim 19, wherein at a reading time, the first FIFO memory and the second FIFO memory of each of the two data storages integrally operate as a single FIFO having a double capacity.
